(19) United States
(12) Patent Application Publication
(10) Pub. No.: US 2005/0149342 A1
(43) Pub. Date: Jul. 7, 2005

(54) Method and apparatus for creating and customizing plug-in business collaboration protocols

(75) Inventors: Tian-Jy Chao, Bedford, NY (US); Liang-Jie Zhang, Cortlandt Manor, NY (US); John Youssef Sayah, Washington, DC (US); Hung -Yang Chang, Scarsdale, NY (US)

Correspondence Address: Ryan, Mason & Lewis, LLP, 90 Forest Avenue,, Locust Valley, NY, 11560, US

(73) Assignee: International Business Machines Corporation, Armonk, NY (US)

(21) Appl. No.: 10/746,755

(22) Filed: Dec. 24, 2003

(51) Int. Cl. G06F 17/60

(52) U.S. Cl. 705/1

(57) ABSTRACT

Techniques are provided for creating and/or customizing protocols for use in applications such as on-demand business collaboration. For example, in a first aspect of the invention, a technique for use in creating and/or customizing a business collaboration protocol comprises the following steps/operations. One or more new data entities to be associated with the business collaboration protocol are added. One or more new messages usable to communicate between a plurality of data entities, including at least a portion of the one or more new data entities, are added. One or more collaboration primitives comprising a set of messages, including at least a portion of the one or more new messages, are created. One or more business constructs comprising a set of collaboration primitives, including at least a portion of the one or more created collaboration primitives, usable for attempting to substantially achieve a business goal, are created.

### FIELD OF THE INVENTION

The present invention generally relates to information management techniques and, more particularly, to techniques for creating and customizing protocols for use in applications such as on-demand business collaboration.

### BACKGROUND OF THE INVENTION

Existing business-to-business (B2B) collaboration protocols such as the Electronic Data Interchange (EDI) or RosettaNet do not adequately support the agility and flexibility required by many collaborative business processes. EDI and RosettaNet transactions have been built to support sharing of well defined and rather rigid data models with known processes and predefined data being exchanged.

However, collaborative business processes such as design collaboration are creative in nature, and not all processes or data can be known in advance. Such processes typically require a multitude of document types being exchanged across virtual teams of various organizations and enterprises. In the case of design collaboration, distributed business entities participate in the design of a product over an information network such as the Internet or World Wide Web. In addition, there is no standard in existing design collaboration techniques to support these types of engineering design collaborations.

Further, manual or semi-automated operations still exist in a product design cycle. Today, people initiate ad-hoc, non-transactional information exchanges via electronic mail, phone, facsimile, file transfer protocols, or shared team rooms without any traceable B2B context to support the monitoring, reporting or managing of the business data. The business impact is a high cost ratio of labor and time and low efficiency due to the inability to obtain real-time status information from the design partners to monitor the on-going projects, tasks, and exchanged documents or handle process exceptions.

### SUMMARY OF THE INVENTION

The present invention provides techniques for creating and/or customizing protocols for use in applications such as on-demand business collaboration. By way of example, the invention provides a plug-in framework and methodology that can be deployed in a B2B environment to enable one or more parties to simultaneously but independently extend a collaborative exchange protocol infrastructure without the need to change the existing B2B infrastructure.

In a first aspect of the invention, a technique for use in creating and/or customizing a business collaboration protocol comprises the following steps/operations. One or more new data entities to be associated with the business collaboration protocol are added. One or more new messages usable to communicate between a plurality of data entities, including at least a portion of the one or more new data entities, are added. One or more collaboration primitives comprising a set of messages, including at least a portion of the one or more new messages, are created. One or more business constructs comprising a set of collaboration primitives, including at least a portion of the one or more created collaboration primitives, usable for attempting to substantially achieve a business goal, are created.

The business collaboration protocol may comprise a collaborative exchange protocol (CxP). The step/operation of adding one or more new data entities may further comprise the steps/operations of determining the one or more new data entities to be added based on base entities, without affecting the base entities, creating one or more ontology definitions, and creating an implementation package for the one or more new data entities that substantially enforces the one or more ontology definitions. The technique may further comprise the step/operation of creating an ontology context file. The ontology context file may comprise an Extensible Markup Language (XML) file. The technique may further comprise the step/operation of creating one or more Java classes for the one or more new data entities that substantially enforce the one or more ontology definitions. The step/operation of creating an implementation package may further comprise one or more of the new data entities having one or more dependent elements associated therewith. At least one of the dependent elements may distinguish its parent entity type using an ontology context file.

The step/operation of adding one or more new messages may further comprise the step/operation of creating the one or more new messages by extending one or more existing messages. The technique may further comprise the step/operation of processing the one or more new messages using a single interface. The single interface may be represented in accordance with a Web service description language (WSDL).

The step/operation of creating one or more collaboration primitives may further comprise the steps/operations of creating a flow for the set of messages between a plurality of data entities using one of a predefined flow template and a manual operation, and generating at least one implementation interface for the one or more collaboration primitives. The predefined flow template may comprise one of a property file and an XML document. The at least one implementation interface may comprise one of a Java application programming interface and a Web services interface.

The step/operation of creating one or more business constructs may further comprise the steps/operations of composing a flow for the set of primitives, and representing the flow in a readable format. The readable format may comprise an XML syntax. The XML syntax may be in the form of a Business Process Execution Language for Web Services (BPEL4WS).

The technique may further comprise the step/operation of multiple parties developing data entities and messages simultaneously within multiple business scenarios, wherein the multiple business scenarios are independent of one another. The technique may further comprise the step/operation of processing the one or more new added messages using a delegation mechanism that redirects the one or more new messages to an appropriate plug-in package without affecting an existing message processing engine.

In a second aspect of the invention, a model for use in creating and/or customizing a business collaboration protocol comprises facilities for enabling performance of the steps of adding one or more new data entities to be associated with the business collaboration protocol, adding one or more new messages usable to communicate between a plurality of data entities, including at least a portion of the one or more new data entities, creating one or more collaboration primitives comprising a set of messages, including at least a portion of the one or more new messages, and creating one or more business constructs comprising a set of collaboration primitives, including at least a portion of the one or more created collaboration primitives, usable for attempting to substantially achieve a business goal.

In a third aspect of the invention, a method of providing a service, in accordance with a service provider, for creating and/or customizing a business collaboration protocol comprising the step of deploying a business collaboration protocol interface operative to: (i) enable the addition of one or more new data entities to be associated with the business collaboration protocol; (ii) enable the addition of one or more new messages usable to communicate between a plurality of data entities, including at least a portion of the one or more new data entities; (iii) enable the creation of one or more collaboration primitives comprising a set of messages, including at least a portion of the one or more new messages; and (iv) enable the creation of one or more business constructs comprising a set of collaboration primitives, including at least a portion of the one or more created collaboration primitives, usable for attempting to substantially achieve a business goal.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating an exemplary architecture of an extended business collaboration where a collaborative exchange protocol is a core component of a hyperchain manager, according to an embodiment of the present invention;

FIG. 2 is a diagram illustrating a hyperchain manager environment, according to an embodiment of the present invention;

FIG. 3 is a diagram illustrating a collaborative exchange protocol stack, according to an embodiment of the present invention;

FIG. 4 is a diagram illustrating an example of plug-in scenarios with a collaborative exchange protocol plug-in framework, according to an embodiment of the present invention;

FIG. 5 is a diagram illustrating an on-demand business collaboration solution life cycle, according to an embodiment of the present invention;

FIG. 6 is a diagram illustrating a collaborative exchange protocol plug-in message inheritance hierarchy, according to an embodiment of the present invention;

FIG. 7 is a diagram illustrating components involved in sending and receiving collaboration messages, according to an embodiment of the present invention;

FIG. 8 is a diagram illustrating a message sender and receiver flow, according to an embodiment of the present invention;

FIG. 9 is a diagram illustrating a collaborative exchange protocol plug-in data entity inheritance hierarchy, according to an embodiment of the present invention;

FIG. 10 is a diagram illustrating an example of classes effected by new data entity and messages, according to an embodiment of the present invention;

FIG. 11 is a diagram illustrating an example of opportunity launch entity classes data model, according to an embodiment of the present invention;

FIG. 12 is a diagram illustrating an overall delegation mechanism from base to plug-in packages, according to an embodiment of the present invention;

FIG. 13 is a diagram illustrating a collaborative exchange protocol message processing delegation mechanism from base to plug-in packages, according to an embodiment of the present invention;

FIG. 14 is a diagram illustrating an application programming interface (API) delegation mechanism from base to plug-in packages, according to an embodiment of the present invention;

FIG. 15 is a diagram illustrating a request for information (RFI) primitive, according to an embodiment of the present invention;

FIG. 16 is a diagram illustrating an information submission (IS) primitive, according to an embodiment of the present invention;

FIG. 17 is a diagram illustrating an RFI business construct, according to an embodiment of the present invention; and

FIG. 18 is a diagram illustrating an illustrative hardware implementation of a computing system in accordance with which one or more components/methodologies of the present invention may be implemented, according to an embodiment of the present invention.

### DETAILED DESCRIPTION OF PREFERRED EMBODIMENTS

The following description will illustrate the invention using an exemplary engineering design collaboration application. It should be understood, however, that the invention is not limited to use with any particular application. Rather, the invention is more generally applicable to any application in which it is desirable to provide efficient and effective information management techniques in a collaborative environment.

In the U.S. patent application identified by Ser. No. 10/665,699, filed on Sep. 19, 2003, subject to assignment to the same assignee as the present invention, and entitled “Methods and Apparatus for Information Hyperchain Management for On-Demand Business Collaboration,” the disclosure of which is incorporated by reference herein, an on-demand information exchange model and techniques are disclosed for use in business collaboration processes. The model and techniques are tailored to individual recipients and support the capability of monitoring and tracking of information delivered and exchanged in accordance with a business collaboration process.

More particularly, the techniques of the above-referenced patent application proposes a new type of annotation representation using a resource description framework (RDF), referred to as “hyperchain RDF,” for annotating a chain of design data, or design chain, and the associated design documents without the need to predefine the schema for each application type. Therefore, the techniques are flexible and suitable for annotating different data types needed for business collaboration, such as design collaboration.

The ability to use annotation to describe nonstandard data and exchange such data with design and trading partners is critical because not everything can be standardized. For protocols like RosettaNet, all elements involved in exchanges and transactions must be standardized and predefined, thus lacking flexibility. Hyperchain technology overcomes such shortcoming by not requiring data exchanges to be standardized and by enabling the sending of nonstandard data within a standard exchange mechanism, which is important for flexible and trackable business collaboration exchanges between design and trading partners.

Design/trading partners of the same or different industries often require different collaboration scenarios to be based on a well-understood approach in lieu of requiring the standardization of all aspects and data elements of exchanges. For example, some design partners in the electronics industry may require support for “design initialization and engineering change management,” while others may want support for “opportunity launch” where an enterprise sales team investigates the possibility of launching a new product idea based on sales leads.

In one illustrative embodiment, the present invention provides techniques to support a rapid, simultaneous but independent development of multiple parallel sets of extensions to the base hyperchain technology referred to herein as Collaborative eXchange Protocols (CxP). CxP uses a hierarchical, top-down approach for the annotation data. For example, in the engineering design collaboration scenario, based on the design process model, annotation data is divided into hierarchical representations, e.g., starting with annotations for design collaboration processes, followed by annotations for design activities specific to CxP, and, then, annotations for design tools used by the business entities involved in the engineering design collaboration scenario.

CxP comprises a set of business constructs composed by a set of predefined collaboration primitives. They capture and automate business collaboration interaction patterns for information exchange based on annotated messages, which are atomic CxP elements. A CxP message is defined as a rudimentary exchange of information between collaborating partners. Multiple choreographed CxP messages form a collaboration primitive, such as RFD (Request for Design) or Request for Information (RFI) primitives. Using CxP business constructs as building blocks, a business collaboration scenario can be composed to represent a sequence of a complex interactions between business partners such as Enterprise Resource Planning (ERP), Product Development Management (PDM), or Supply Chain management (SCM) or other existing (Legacy) applications.

One goal of a CxP infrastructure is to provide a flexible and extensible base so that, with minimum effort, design or trading partners can add new extensions or customize the old to suit their needs. Advantageously, the present invention provides a CxP plug-in framework that enables the easy plugging-in of new business collaboration scenarios.

Another important aspect of creating and customizing the Cxp is to build business process templates. The invention also provides a mechanism to provide template descriptions for both CxP primitives and business constructs, which will be described in detail below.

Thus, in illustrative embodiments, the invention provides two mechanisms to create and customize plug-in business collaboration protocols:

(A) CxP Plug-in Framework (described in detail below in section I); and

(B) CxP Primitives and Business Construct Templates (described in detail below in section II).

I. CxP Plug-in Framework

The CxP plug-in framework enables simultaneous but independent extensions to the CxP base by multiple parties. The framework provides the protection and isolation needed for such simultaneous and independent extensions. Three important features the CxP plug-in framework provides to support the plug-in scenarios are:

1. Extension—New CxP data entities and messages of the plug-in scenarios can be extended or inherited from the base data entities and messages with minimum effort.

2. Delegation—The plug-in packages are delegated by the CxP base to perform plug-in related message and data entity type checking as well as message invocation and processing.

3. Containment of Changes—All changes needed to support a new plug-in scenario are self-contained within the appropriate plug-in package, without affecting the CxP base or other scenarios. Such protection is provided at both development time and runtime.

The extensibility feature enables new CxP messages and data entities of a new scenario to be developed with minimum work by extending the CxP base messages and data entities. Extending and inheriting from the CxP base not only reduces the development time and effort but also promotes reusability of the stable base, thus enhancing the stability of the extensions. Therefore, multiple plug-in scenarios can be easily added by extending the CxP base.

In addition, declarative ontology context information may provide the reference to which type of data entity a message is associated without the need for a code change. For example, as described in N. F. Noy et al., “Ontology Development 101: A Guide to Creating Your First Ontology,” 2002, the disclosure of which is incorporated by reference herein, ontology can be used to share a common understanding of the structure of information among people or software agents, as well as to enable reuse and analysis of a domain knowledge that may be separated from the operational knowledge.

In accordance with the containment feature, during development time as well as runtime, each participating partner is protected by a given plug-in package for the particular scenario being developed, which is isolated from other partners' plug-in packages. Each partner can only change things within his plug-in package boundary and does not have the capability to make changes outside his plug-in package, i.e., in the CxP base or in other partners' plug-in packages.

At runtime, this isolation effectively eliminates any illegal modifications, malicious or benign, intentionally or unintentionally, outside the plug-in package that can affect the stability of the CxP base or other partners' scenario and cause them to stop functioning. With the plug-in package environment provided by the CxP plug-in framework, any harmful changes will only crash the partner's own scenario without affecting the CxP base or other scenarios. Therefore, the framework not only ensures the stability of the CxP base but also protects one design partner from being impacted by changes made by other partners.

In addition, the framework enables the ability to build tools to automate the code generation, thus cutting down development cycle. Without the framework's ability to isolate and shield changes from different design partners, tooling or automation would be ineffective because all changes would affect the base code and, as a result, affect other partners' scenarios. The inventive framework also enables the use of code templates, tooling for code generation, and wizard-guided customization environment for CxP development.

Moreover, a single Web service is all that is needed to process various CxP messages from multiple scenarios, thus avoiding the need to create additional new Web services to process new CxP messages. This also means the elimination of the need to change WSDL (Web Service Definition Language) files for the Web service, and to rebuild or redeploy Web services when new CxP messages are added. This saves in development as well as testing time, thus enabling easy extensions of new CxP messages to support new collaborative scenarios.

Another advantage of the CxP plug-in framework of the invention is that the framework eliminates a considerable amount of regression testing that would have been required without the isolation and protection of individual scenario provided by the framework. That is, without the framework, any changes of the new extensions would cause multiple changes, big and small, to the base because they would not be self-contained or isolated from the base. These changes would be spread among several base modules, with some providing definitions of the new messages and data types, some checking and validating the new types, some loading and saving the new types, some sending new CxP messages, and some processing these new CxP messages.

For example, each new message is estimated to need about 10 base files changes. If a new scenario, Design Collaboration Refinement, with 6 messages were to be added, it would be 60 (10*6) changes. If another scenario, Engineering Changes, with 5 messages were to be added, it would be 50 (10*5) changes. And the total would be 110 base changes.

For each change, it could potentially cause the base or other scenario such as Initial Design (4 messages+acknowledgment) and Opportunity Launch (1 message+acknowledgment) not to work, thereby requiring regression testing of the existing scenarios. Two examples below are given:

a) 30 regression test cases needed when adding 6 Design Collaboration Refinement messages:
6 (Design Collaboration Refinement messages)*(4 (Initial Design messages)+1 (Opportunity Launch))=30 (regression test cases).

b) 55 regression test cases needed when adding 5 Engineering changes messages:
5 (Engineering changes)*(6 (Design Collaboration Refinement messages+4 (Initial Design messages)+1 (Opportunity launch))=5*11=55 (regression test cases).

As more new scenarios are added, the number of changes and regression test cases would continue to go up. With the constant changes coming in, the system would be vulnerable and subject to bad changes and fixes, which could cause it to stop functioning properly. Further, it would be difficult to keep track of all the changes from multiple scenarios by multiple parties, which would render simultaneous development extremely difficult, if not impossible.

Advantageously, in accordance with the CxP plug-in framework, the invention provides the foundation, isolation, and protection needed for rapid, simultaneous extensions to the CxP base, with each extension independent of one another. All changes are self-contained and do not affect the base or other scenarios.

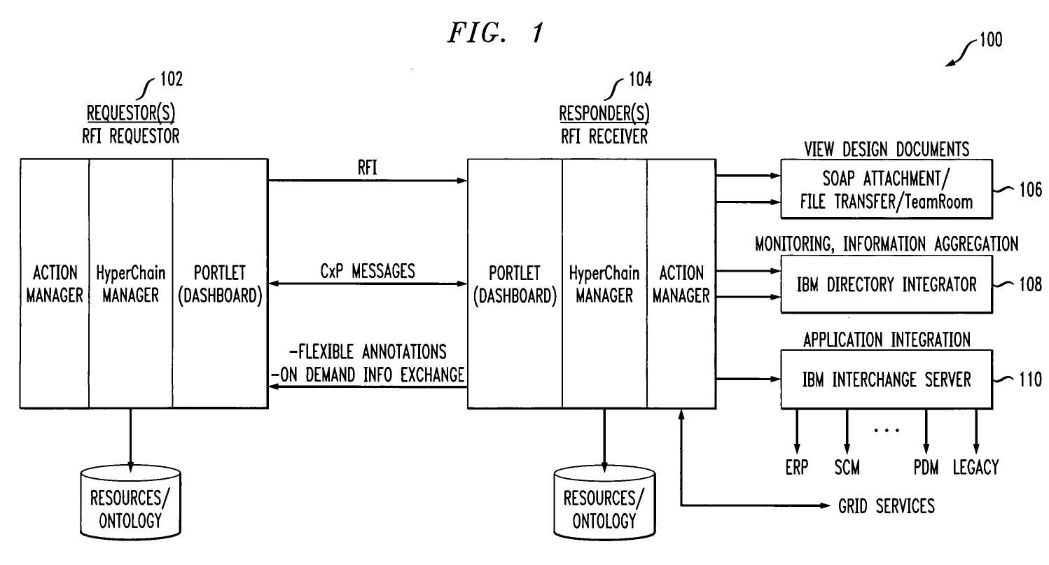

Referring initially to FIG. 1, a diagram illustrates an exemplary deployment architecture 100 of an extended business collaboration where a collaborative exchange protocol is a core component of a hyperchain manager, according to an embodiment of the present invention. As shown, a design center is formed by a sender (Requestor 102) of a CxP collaboration message RFI and a receiver (Responder 104) of this RFI message. The sender and the receiver are thus considered design partners.

An action manager, which is integrated as part of the engine of the CxP framework for on-demand business collaboration and which will be described further below, receives collaborative messages (or CxP) messages from a design partner side, which can be a Web portal (or a portlet in a collaboration dashboard). The “dashboard” refers to a web interface environment from which a user, according to his or her role and responsibilities, has access to applications through specific web interfaces (called portlets) to relevant applications and functions, during the execution of a business process scenario in a collaborative business activity.

Each message contains meta-data or annotations describing the documents to be exchanged, such as the file name, size, author, application to use to open the design file, etc. In addition, annotations can also specify a set of integration activities to be performed, representing a new application to be integrated such as FTP (file transfer protocol), link to a team room for storing documents (106), connect to a directory service such as a directory integrator 108, connect to grid services, or an invocation of adaptors, through a B2B software such as an interchange server 110, which connect to applications such as those in ERP or PDM systems.

After receiving and processing the CxP messages, the action annotations are parsed and handed over to the action manager, which will in turn invoke the methods as specified in an adaptation layer to connect to the actual application to be integrated. The response is sent back to the design partner as an acknowledgment. In this example scenario, action manager greatly simplifies the work of the CxP framework to integrate with multiple backend applications (ERP, SCM, etc.). The knowledge needed during the operation of the action manager and the hyperchain manager (described further below) is stored and accessed in a resources/ontlogy database.

More particularly with respect to FIG. 1, the communication between the requestor 102, or sender, and the receiver 104 of a CxP Message is peer-to-peer and distributed. One requestor can send messages to multiple receivers, and therefore, it is a one-to-many relationship. The example CxP message that is being sent is the RFI message, and within the message, there exists a link that points to the actual documents that can be downloaded as needed, rather than the document being an attachment inside of the message. This is the on-demand or pull model where information retrieval is controlled by the receiver and based on his or her needs. On each requestor and receiver side exists the extended business collaboration (eBC) infrastructure comprising a hyperchain manager that manages the resources or ontology created for the collaboration, information access portal (or dashboard) for the user to access the resources managed by the hyperchain manager, and the action manager that can process actions annotated in a CxP message and invoke proper target applications to perform the desired actions, thus enabling the business process integration with the back-end applications, such as file transferring using SOAP or FTP, IBM Directory Integrator that aggregates data from design partners' site, and IBM Interchange Server, which can in turn invoke other target applications, e.g., ERP, SCM, PDM, and other legacy applications.

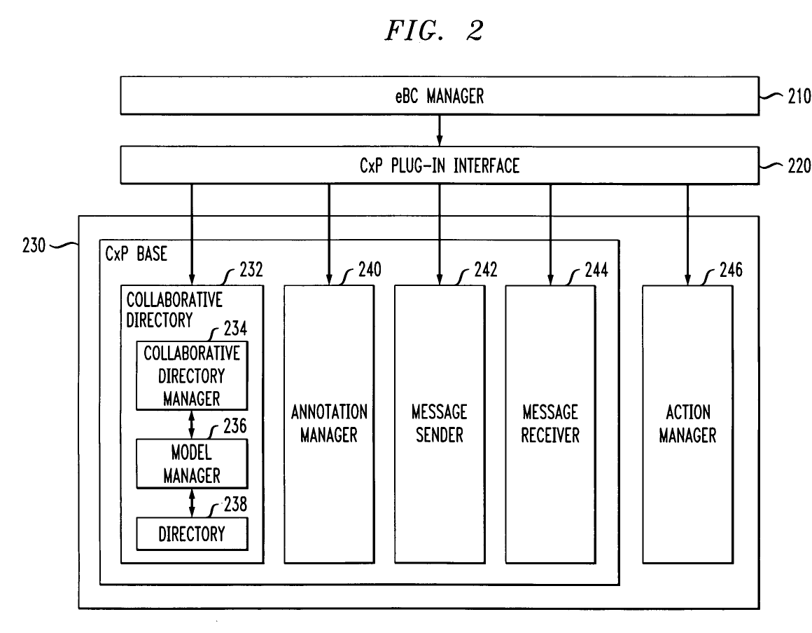

Referring now to FIG. 2, a diagram illustrates a hyperchain manager environment, according to an embodiment of the present invention. As shown in FIG. 2, a hyperchain manager serves as a CxP engine with a CxP plug-in interface associated therewith. The architecture 200 in FIG. 2 comprises an extended business collaboration (eBC) manager 210, a CxP plug-in interface 220 and a hyperchain manager 230.

Hyperchain manager 230 is preferably on a J2EE platform with WebSphere (IBM Corporation of Armonk, N.Y.) as an example. Hyperchain manager 230 comprises collaborative directory 232 (with collaborative directory manager 234, model manager 236 and directory 238), an annotation manager 240, a message sender 242, a message receiver 244 and an action manager 246. It is to be appreciated that collaborative directory 232, annotation manager 240, message sender 242 and message receiver 244 are collectively considered the CxP base.

A description of the components of architecture 200 of FIG. 2 will now be given.

eBC Manager 210—This is the main component that interfaces with external components such as a portal, which is currently deployed on WebSphere Portal Server (WPS), which is an information access portal that can access business collaboration information managed by eBC manager 210. Further, it is to be understood that the portals and dashboard are applications that can be used to access the CxP core engine via an application programming interface (API) layer provided by eBC manager 210.

CxP plug-in interface 220—This is the component that provides a flexible and extensible framework to enable easy addition of new collaboration scenarios, comprising new CxP messages and data entities, to the CxP base. This component will be described in further detail below.

CxP Base:

Collaboration Directory Manager 234—This is the component that manages the resources tracked by the CxP engine, such as organizations (partners), users, projects, tasks, etc. Resources are RDF-based, supporting both Extensible Markup Language (XML) and DB2 (IBM Corporation of Armonk, N.Y.). An RDF (resource description framework) toolkit referred to as “Jena” (available from Hewlett Packard) may be employed.

The information managed by the collaborative directory manager 234 is stored in directory 238 that interfaces through model manager 236 which accesses and interprets ontology definitions for base elements in CxP and the ontology context capturing the relationships, between base data entity elements, supporting the execution of the CxP protocol. Further, model manager 236 manages restoring and retrieving of resources of data models in RDF format. Such resources, Project, Task, Organization, User and CxP messages, are created through business collaboration and collectively referred to as collaborative directory 238, or directory for short.

Message Sender 242/Message Receiver 244—These are Web service components that send and receive CxP messages. In one embodiment, the messages are SOAP-based (Simple Object Access Protocol). However, such messages may be transported via other transport mechanisms such as MQ (message queuing) or FTP (File Transfer Protocol).

Annotation Manager 240—This component manages annotation/ontology and processes the metadata or annotations created for the documents exchanged via CxP messages. Examples of annotations are file names, file types, versions, author names, etc. In addition, annotations can also be used to specify “actions” to be performed on the documents. Examples of such actions may be “review” document, perform “RFT” (Reliable File Transfer) and send actions to legacy applications like ERP and PDM, etc.

Action Manager 246—This component serves as an integration layer to back-end legacy applications as well as components like RFT. The annotations in the received CxP messages are parsed and forwarded to action manager 246 to invoke the proper actions on the documents.

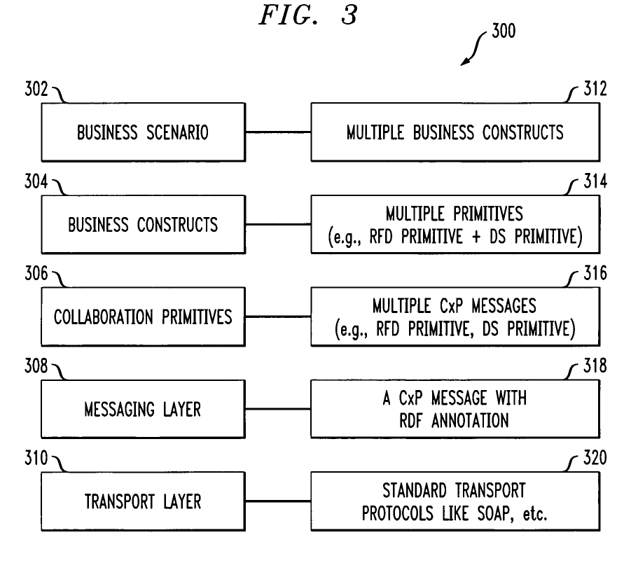

Referring now to FIG. 3, a diagram illustrates a collaborative exchange protocol (CxP) stack, according to an embodiment of the present invention. As shown, in CxP stack 300, the following elements are defined: business scenario 302, business constructs 304, collaboration primitives 306, messaging layer 308 and transport layer 310. The corresponding descriptions on each layer are multiple business constructs 312, multiple primitives 314 (e.g., request for design (RFD) primitive and design submission (DS) primitive), multiple CxP messages 316 (e.g., RFD primitive, DS primitive), CxP message with RDF annotation 318 and standard transport protocols 320 (e.g., SOAP, etc.).

In messaging layer 308, RDF is used to represent business collaboration annotation which is called hyperchain annotation. On top of that, a set of primitives are defined as collaboration primitives 306 to help the communication and collaboration between the parties. A business construct 304 is a basic unit of message exchange sequences which serve a single business goal. For example, an RFD business construct is used when a request for design is initialized, e.g., a design center. A product design team can send RFDs to its design partners to do various designs. Following that, an accept or reject primitive may be received from the design partners. Later, a design partner may submit its design results by DS primitive.

Thus, in accordance with the messaging layer, CxP messages are built. A CxP message is an atomic CxP element and may be a rudimentary exchange of information between trading partners, e.g., an RFD message. A set of choreographed messages forms a primitive, such as RFD primitive comprising several message exchanges, i.e., RFDMessage, ReceiptAck Message, and Acceptance Message, etc. Furthermore, one or more primitives form a business construct, e.g., RFD Business Construct, comprising two primitives, e.g., RFD primitive and DS primitive.

A business scenario 302 comprises multiple business constructs, representing sequences of a complex interaction between business partners, e.g., Design Initialization, Engineering Change Management and Opportunity Launch, etc.

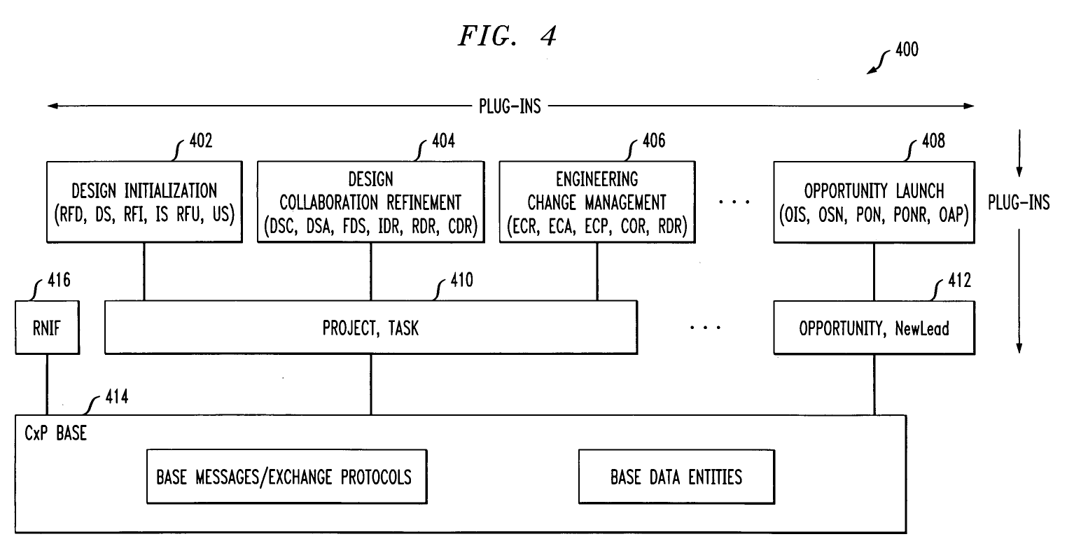

Referring now to FIG. 4, a diagram illustrates an example of plug-in scenarios with a collaborative exchange protocol (CxP) plug-in framework, according to an embodiment of the present invention. It is to be appreciated that framework 400 shown in FIG. 4 may be implemented in accordance with CxP plug-in interface 220 of FIG. 2. More particularly, FIG. 4 illustratively depicts the plug-in framework provided by CxP as well as several example plug-in scenarios, e.g., Design Initialization 402, Design Collaboration Refinement 404, Engineering Change Management 406 and Opportunity Launch 408.

Each scenario comprises several primitives, made up of a set of CxP messages, e.g., RFD, RFI, RFU, IS or US (Information or Update Submission), and similarly defined business constructs such as Engineering Change Request (ECR), Engineering Change Acceptance (ECA), Opportunity Acceptance Plan (OAP), etc., which can be extended using various base CxP message types.

The full names of the potential set of CxP messages in the above-mentioned four plug-in scenarios are as follows. For Design Initialization 402, there are RFD (Request for Design), Design Submission (DS), Request for Information (RFI), Information Submission (IS), RFU (Request for Update (RFU), and Update Submission (US). For Design Collaboration Refinement 404, there are DSC (Design Specification Change), DSA (Design Specification Agreement), FDS (Finalize Design Specification), IDR (Initiate Design Review), RDR (Request Design Review), and CDR (Close Design Review). For Engineering Change Management 406, there are ECR (Engineering Change Request), ECA (Engineering Changer Accept), ECP (Engineering Change Propagate), COR (Change Order Review), and COA (Request Design Review). For Opportunity Launch 408, there are OIS (Opportunity Identification & Specification), OSN (Opportunity Specification & Notification), PON (Plan for Opportunity Notice), OAP (Opportunity Acceptance & Plan), and IDP (Initiate Design Process).

In addition, there are new data entities, e.g., Project, Task 410 and Opportunity, NewLead 412, which are examples of extensions to the CxP base 414 data entities, e.g., BaseProject/BaseTask pair. The framework may support the RosettaNet Implementation Framework (RNIF) 416.

Notice that one or more scenarios can use the same set of data entities, which are extended from the CxP base entities. For examples, three scenarios relating to engineering design, e.g., Design Initialization 402, Design Collaboration Refinement 404 and Engineering Change Management 406, are built on data entities of Project and Task 410, while the other scenarios, e.g., Opportunity Launch 408, are built on data entities of Opportunity and NewLead 412. Both pairs of Project/Task and Opportunity/NewLead are data entities extended from the CxP base entities. By the same token, each scenario is built on CxP base messages to form new messages, such as RFD, RFI, RFU, DSC, DSA, ECR, OIS, OAP, etc.

Advantageously, the CxP plug-in framework makes it easy to plug in new collaboration scenarios on top of the CxP base, such as Design Initialization, Design Collaboration Refinement, Engineering Change Management, or Opportunity Launch, which can require new data entities and messages to be added to provide the support.

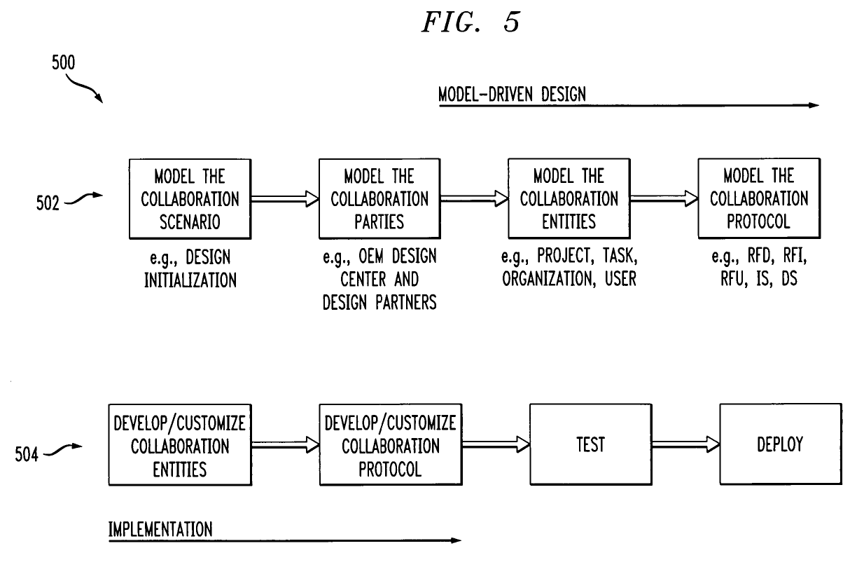

Referring now to FIG. 5, a diagram illustrates an on-demand business collaboration solution life cycle 500, according to an embodiment of the present invention. More particularly, FIG. 5 describes the life cycle of creating and customizing a solution based on CxP. It is to be understood that the collaboration protocols comprise CxP messages, forming CxP primitives, which in turn form CxP business constructs. Multiple business constructs become a collaboration scenario.

The first half of life cycle 500 is considered a design and modeling phase 502. In this phase of the cycle, a model-driven design methodology is used to model a new collaboration scenario, the collaboration parties involved in the scenarios, the collaboration entities needed, as well as the collaboration protocols, comprising CxP messages, primitives and business constructs, which altogether form the business scenario at hand.

The second half of life cycle 500 is considered an implementation phase 504, which involves development and customization of the collaboration entities and protocols identified by the first half of the life cycle, followed by testing and deployment stages.

Thus, the CxP plug-in framework makes it easy to create, customize, and plug in new collaboration scenarios on top of the CxP base due to its extensibility, delegation and self-containment features for both development and runtime of the system.

An explanation of CxP resources will now be given.

CxP are based on the resource description framework (RDF), which is a standard for describing resources. A resource is identified by a uniform resource identifier (URI) and has properties. Resources defined in CxP are captured in an XML-based ontology file.

Some of the CxP resources map into Java classes, such as Project, Task, Organization, User, etc., and some do not because they are properties, comprising fields in a Java class, such as projectName, creationTime, etc. Furthermore, certain Java classes that map into entities defined in CxP are termed data entity classes or data entities for short, such as Project, Task, Organization, and User, etc. Other Java classes that map into messages defined in CxP are termed message classes, such as RFD (Request for Design), RFI (Request for Information), etc.

The remainder of this section (section I) describes in detail processes for providing both new data entities and new messages based on the CxP base data entities and messages.

New CxP data entities and messages of the plug-in scenarios can be extended or inherited from the base data entities and messages for increased reusability.

Each scenario comprises new messages, which can be extended based on various base CxP message types. One can create a new CxP message by extending any of the existing five types of messages: Message, Requirement Message, Attachment Message, AcceptanceAck Message, and ReceiptAck Message. It is to be appreciated that the last four message types are inherited from the base Message class. New messages for various scenarios, e.g., RFD, RFI, RFU, DSC, DSA, ECR, OIS, OAP, etc., can be created easily by extending any one of the four above-mentioned messages.

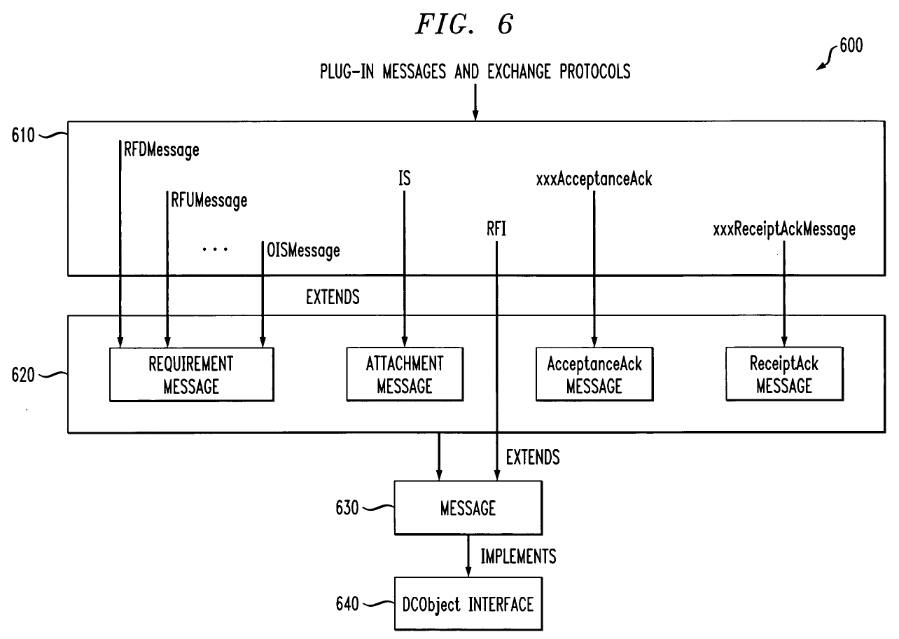

Referring now to FIG. 6, a diagram illustrates a collaborative exchange protocol plug-in message inheritance hierarchy 600, according to an embodiment of the present invention. As shown, base components of general messages for CxP are base constructs 610 such as Request for Update, Design or Opportunity Information Specification (RFU, RFD, OIS), summarizing requirement, or a document or information exchange such as Information Submission (IS), Handshake Structures (Acceptance Acknowledgment) or Receipt of Message Notifications. The base constructs 610 are inherited from message models 620 such as Requirement Message, Attachment Message, etc. This two-level hierarchy may be complemented by a general Request for Information (RFI) construct that inherited from Message class 630. The messages are then implemented for specific business scenarios such as Design Collaboration Object Interface (DC Object Interface) 640.

More particularly, each scenario comprises new Messages, which can be extended based on various base CxP message types. One can create a new CxP message by extending any of the existing five types of messages: Message, Requirement Message, AttachmentMessage, AcceptanceAck message, and ReceiptAck messages, and the last four are inherited from the base Message class, which implements a Java interface, DCObject. New messages for various scenarios, RFD, RFI, RFU, DSC, DSA, ECR, OIS, OAP, etc., can be created easily by extending any one of the four above-mentioned messages.

Table 1 below describes criteria to decide which base Message type to extend with:

TABLE 1
Message Extensions and Code Templates

| Base Message | | |
|---|---|---|
| Class Name | Usage Description | Code Template |
| RequirementMessage | Extend this class when | RFD.java |
| | a new message contains | |
| | Requirement class. | |
| AttachmentMessage | Extend this class when | IS.Java |
| | a new message contains | |
| | no Requirement but | |
| | contains attachments, | |
| | i.e. SOAP attachment | |
| Message | Extend this class when | RFI.java |
| | a new message is basic- | |
| | ally a base Message, | |
| | which is no Require- | |
| | ment or but has | |
| | additional fields, | |
| | i.e. infoURL | |
| AcceptanceAck | Extend this class when | AcceptanceAck.java |
| | a new message is basic- | |
| | ally a Message but con- | |
| | tains additional field(s), | |
| | to indicate “Accept” | |
| | or “Reject”. | |
| ReceiptAck | Extend this class when | ReceiptAck.java |
| | a new message is basic- | |
| | ally a Message with no | |
| | additional fields, | |
| | indicating receipt of | |
| | a message. This message | |
| | is normally combined | |
| | with other message, | |
| | e.g. RFD message, | |
| | to form a primitive. | |

When defining a new message, it may be advisable to add the ontology definitions to the ontology file for the new message. An example of a new message using RFU is shown below in List 1:

List 1. Ontology for RFU Message

<daml:Class rdf:ID=“RFU”>
<rdfs:label>RFU</rdfs:label>
<rdfs:comment>Request for Update</rdfs:comment>
<rdfs:subClassOf rdf:resource=“#RequirementMessage”/>

</daml:Class>

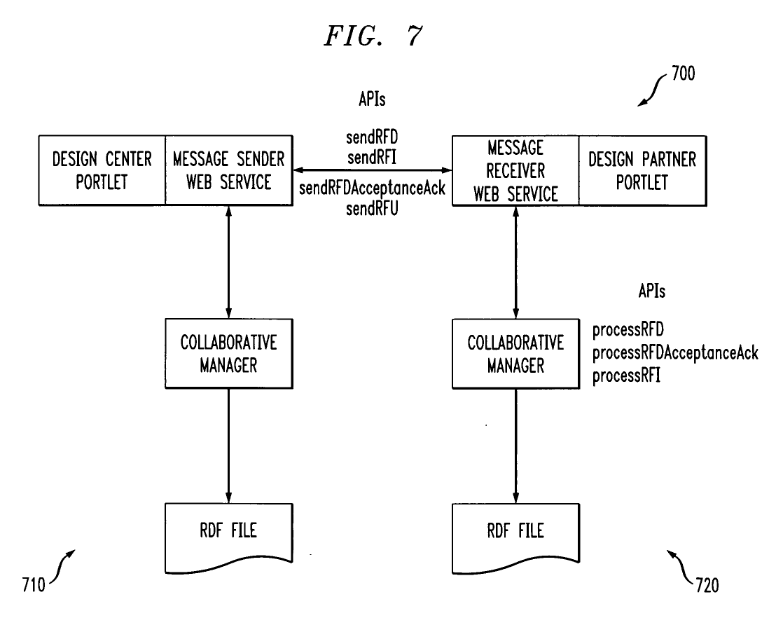

Referring now to FIG. 7, a diagram illustrates components involved in sending and receiving collaboration messages, according to an embodiment of the present invention. More particularly, FIG. 7 describes an overview 700 of CxP message processing between sender 710 and receiver 720. Each CxP Message is sent via an API defined in CollabMgr class, e.g., sendRFD or sendRFI, etc., and the message is processed by a single Web service method defined in WSDL of CxP, i.e., processTransaction, which invokes a processTransaction( ) (not shown) defined in CollabMgr class. Internally, the processTransaction( ) invokes the appropriate processing method, i.e., processRFD, processRFI, or processRFDAcceptanceAck, etc., corresponding to a CxP primitive. The processing logic also sends a ReceiptAck message back to the sender. The sendRFD API defined in CollabMgr class invokes processTransaction( ) of MsgReceiverProxy (not shown) at the receiver side, which in turn invokes the Web service method processTransaction( ).

One reason why there is only one Web service representing all internal processing methods is so that when a new CxP primitive is added, there is no need to add a new Web service to process the new message or to change WSDL. In addition, there is no need to redeploy the Web service. All that is needed is to invoke processTransaction( ) providing the new processing method as a parameter in the input.

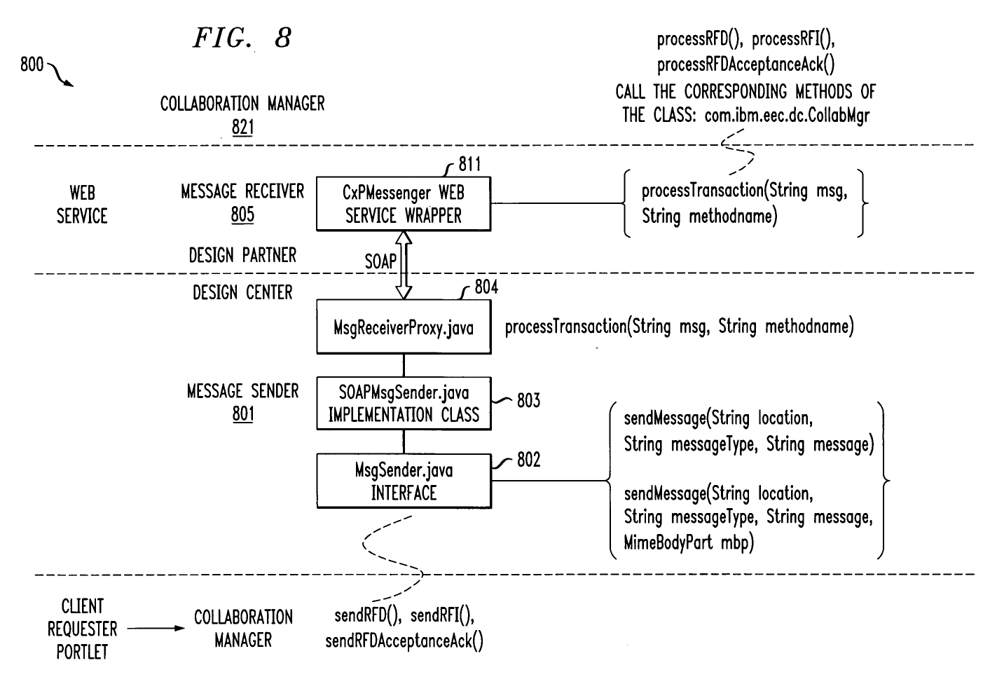

Referring now to FIG. 8, a diagram illustrates a message sender and receiver flow 800, according to an embodiment of the present invention. Note that, as depicted in the figure, there is only one Web service method, processingTransaction( ), used to invoke various Web services. As shown, sender side 801 includes interface 802, implementation class 803 and proxy 804. The interface 802 defines a method called sendMessage with two different input parameters. The implementation class 803 is used to construct a SOAP (Simple Object Access Protocol) message for delivery. The proxy 804 invokes the method processTransaction defined in a Web service deployed at receiver side 805.

At receiver side 805, web service wrapper 811 receives the invocation request from message sender 801. The method processTransaction defined in web services wrapper 811 interacts with collaboration manager 821, which has different specific methods for processing various message contents. The example methods, namely, processRFD( ), processRFI( ) and processRFDAcceptanceAck( ), are specially designed for processing RFD message, RFI message and RFD Acceptance acknowledgment, respectively.

List 2 that follows is the service WSDL for CxP:

List 2. CxP Service WSDL

<?xml version=“1.0” encoding=“UTF-8”?>
<definitions name=“MsgReceiverService”

targetNamespace=“http://localhost:8080/CxPMessenger/wsdl/

MsgReceiver-service.wsdl”

xmlns=“http://schemas.xmlsoap.org/wsdl/”
xmlns:binding=“http://www.msgreceiver.com/definitions/

MsgReceiverRemoteInterface”

xmlns:soap=“http://schemas.xmlsoap.org/wsdl/soap/”
xmlns:tns=“http://localhost:8080/CxPMessenger/wsdl/

MsgReceiver-service.wsdl”>

<import

location=“http://localhost:8080/CxPMessenger/wsdl/

MsgReceiver-binding.wsdl”

namespace=“http://www.msgreceiver.com/definitions/
MsgReceiverRemoteInterface”/>

<service name=“MsgReceiverService”>

<port binding=“binding:MsgReceiverBinding”
name=“MsgReceiverPort”>

<soap:address location=“http://localhost:8080/

CxPMessenger/servlet/rpcrouter”/>

</port>

</service>

</definitions>

List 3 that follows shows the binding WSDL for CxP with one Web service method, processingTransaction( ), including SOAP attachment processing:

List 3. CxP Binding WSDL

<?xml version=“1.0” encoding=“UTF-8”?>
<definitions name=“MsgReceiver-binding”

targetNamespace=“http://www.msgreceiver.com/definitions/
MsgReceiverRemoteInterface”
xmlns=“http://schemas.xmlsoap.org/wsdl/”
xmlns:soap=“http://schemas.xmlsoap.org/wsdl/soap/”
Xmlns:tns=“http://www.msgreceiver.com/definitions/
MsgReceiverRemoteInterface”
xmlns:xsd=“http://www.w3.org/2001/XMLSchema”>
xmlns:mime=“http://schemas.xmlsoap.org/wsdl/mime/”
xmlns:soapenc=“http://schemas.xmlsoap.org/soap/encoding/”
<message name=“processTransactionRequest”>

<part name=“msg” type= “xsd:string”/>
<part name=“methodName” type=“xsd:string”/>
<part name=“attachment” type=“xsd.string”/>

</message>
<message name=“processTransactionResponse”>

<part name=“result” type=“xsd.string”/>

</message>
<portType name=“MsgReceiver”>

<operation name=“processTransaction” parameterOrder=“msg methodName”>

<input message=“tns:processTransactionRequest”

name=“processTransactionRequest ”/>

<output message=“tns:processTransactionResponse”

name=“processTransactionResponse”/>

<operation>

</portType>
<binding name=“MsgReceiverBinding” type=“tns:MsgReceiver”>

<soap:binding style=“rpc” transport=“http://schemas.xmlsoap.org/soap/http”/>

<operation name=“processTransaction”>

<soap:operation soapAction=““style=“rpc”/>
<input name=“processTransactionRequest”>

<mime:multipartRelated>

<mime:part>

<soap:body

encodingStyle=“http://schemas.xmlsoap.org/soap/encoding/”

namespace=“http://tempuri.org/com.ibm.eec.dc.web.MsgReceiver”

parts=“msg methodName”
use=“encoded”/>

</mime:part>
<mime:part>
<mime: content part=“attachment” type=“text/html”/>
<mime:part>
<mime:multipartRelated>

</input>
<output name=“processTransactionResponse”>

<soap:body

encodingStyle= “http://schemas.xmlsoap.org/soap/encoding/”
namespace=“http://tempuri.org/com.ibm.eec.dc.web.MsgReceiver”

use=“encoded”/>

</output>

</operation>

</binding>

</definitions>

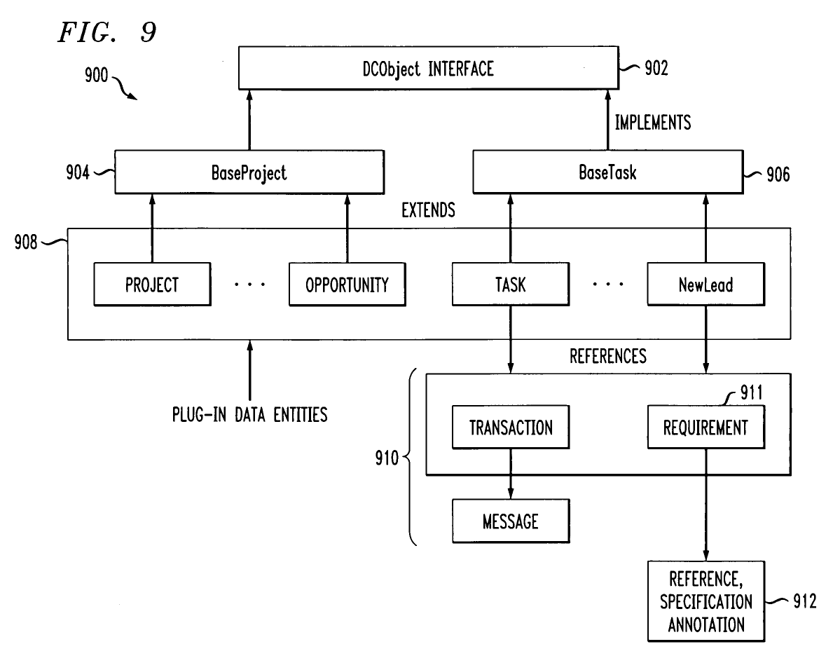

Referring now to FIG. 9, a diagram illustrates a collaborative exchange protocol (CxP) plug-in data entity inheritance hierarchy 900, according to an embodiment of the present invention. More particularly, FIG. 9 describes the inheritance structure for the pluggable framework to support the plug-in data entities. As shown, DC Object Interface 902 is a specific business scenario. The base data entities are BaseProject 904 and BaseTask 906. They can be extended to create new entities 908, e.g., Project and Task in the DesignInit plug-in package, supporting Design Initialization, Refinement and Engineering Change, or Opportunity and NewLead in the OpptLaunch plug-in package, supporting Opportunity Launch.

Note that both Project/Task and Opportunity/NewLead reuse the dependent elements 910, such as Transaction, Message, Requirement, etc. The way a Transaction can distinguish its parent entity type, i.e., Task or NewLead is through the use of ontology context file. Reference and Specification Annotation 912 is the set of models used to capture the information related to the ontology and model of specifying general activities such as requirements or information structures pertinent to the domain and business scenarios for collaboration, in this case, to be used to define design collaboration CxP messages. The example reference and specification annotation shown in FIG. 9 is derived from the Requirement class 911.

Several steps are involved in adding a new CxP entity types:

1) Determine what new data entities to add (step 3 in the solution life cycle). No code changes are needed here.

2) Create ontology definitions in XML file (e.g., for documentation purposes only) as listed in Table 1 below.

TABLE 1
Sample Ontology definitions for Opportunity
and NewLead data entities

| Type of Change | Details of changes |
|---|---|
| 1. Added new properties | 1) PROP_PURSUER is the property |
| | between Organization and Opportunity |
| | (similarly, an org is the owner of |
| | a project). |
| | 2) PROP_WORKER is property between |
| | NewLead and the Organization that |
| | works on it (similarly, an org is the |
| | performer of a task) |
| 2. Add entities and Messages | Opportunity, NewLead |
| | OIS, OSN, PON, PORN, OAP, IDP |
| | OISTransaction, |
| 3. Object Property | ForOpportunity, forNewLead |

3) Create ontology context file the new data entities and if the new entities are using Transaction, modify ontology context for the Transaction class to indicate its parents.

The ontology information for data entities are captured properties files and begin with, and perhaps migrate to, XML files as a need arises. There are four new ontology files created as part of the pluggable framework in addition to the original elemental information about design collaboration that is captured under a dc.properties file.

Table 2 below provides details:

TABLE 2
DataEntity ontology

| Data Entity Name | Ontology File name |
|---|---|
| Project | ProjectContext.properties |
| Task | TaskContext.properties |
| Requirement | RequirementContext.properties |
| Transaction | TransactionContext.properties |
| NewLead | NewLeadContext.properties |
| Opportunity | OpportunityContext.properties |

In List 4 below, a sample properties file, TransactionContext.properties, is shown. It is used as an example to explain the contents of these ontology properties files.

List 4. TransactionContext.properties

DataEntityType=Transaction
totalProperties=2
parent1=Task
parentProperty1=forTask
parent2=NewLead
parentProperty2=forNewLead

In the file, the type of the data entity is Transaction, and there are a total of two properties. In accordance with RDF, each property is represented by an arc, or a statement in an RDF graph, and each statement asserts a fact about a resource. Also, a statement is described as a triple, namely, the subject, the predicate and the object.

The ontology contexts for each property for this entity, e.g., forTask, is recorded with one per each object (or parent), e.g., Task, where the resource is pointed to by the arc. The name/value pair of totalProperties=2 denotes that there are two repeating groups of parentx and parentPropertyx where x indicates an ordinal number starting from numeric 1.

4) Create Java classes for the new data entities enforcing the ontology definitions. This involves inheriting and extending from the existing data entities, and using code templates.

Referring to FIG. 10, a diagram illustrates an example of classes effected by new data entity and messages, according to an embodiment of the present invention. More particularly, FIG. 10 shows the effect of adding new data entities and messages to the CxP classes. In this application, the class diagram itself is not our focus. There are a few classes (Opportunity class 1001, Project class 1002, Task class 1003, NewLead class 1004, OIS class 1005, IS class 1006, RFI class 1007) that need to be newly created. Note that all other classes are considered unchanged classes. A new Java class package, plug-in Package 1010, needs to be developed to create resource and association based on additional parent entity type using the parent field defined in the ontology context for Transaction, e.g., Task and NewLead. A new parent type for the Transaction will need to be added to its context file and the value is obtained by invoking a method in Transaction class.

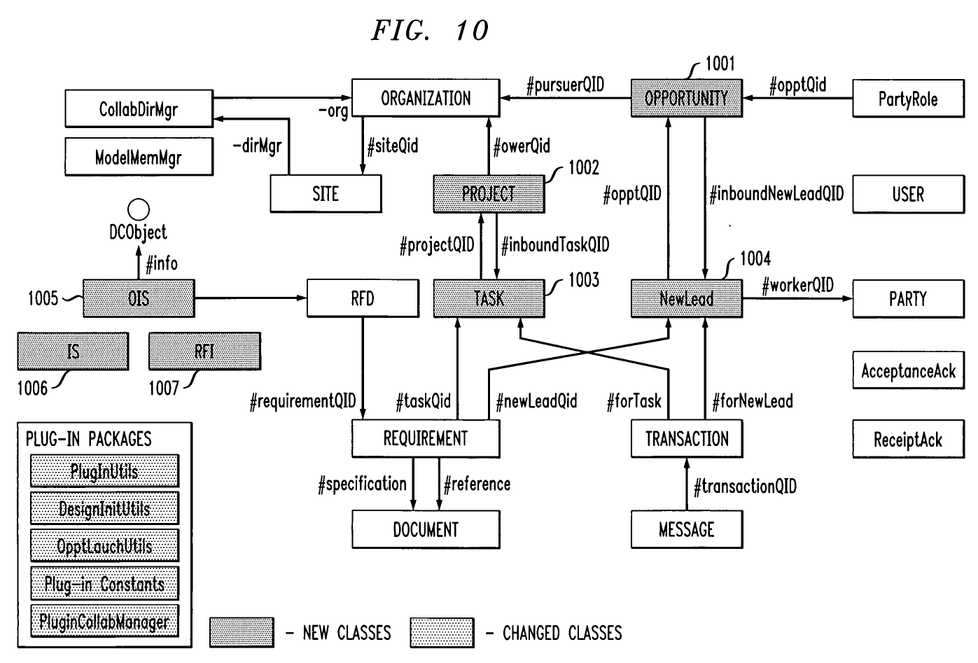

Referring now to FIG. 11, a diagram illustrates an example of opportunity launch entity classes data model, according to an embodiment of the present invention. More particularly, FIG. 11 shows that two new data entities, i.e., Opportunity and NewLead, have been added to the existing data entities classes.

As shown, root class (1102) is the Site, which can be associated with zero or more Organization classes (1104), representing businesses entities. Each Organization class can be associated with zero or more Project classes (1106) and Opportunity classes (1191). A Project class can be associated with zero or more Task classes (1108). An Opportunity class can be associated with zero or more NewLead classes (1192) and zero or more CollabSpaces (1107). Each Task class can be associated with zero or more Transaction classes (1110), which in turn can be associated with zero or more (CxP) Message classes (1112). In addition, each Task class can be associated with zero or more Requirement classes (1114), representing requirements to be sent to the partners. Each Requirement class can be associated with zero or more Annotation (1116, which may include metadata to describe the requirement), Specification (1118), and Reference (1120) classes.

Annotation Property (1121) is the Java class that the actual annotations are created from, e.g., filename, authorname, price, etc. That is why the relationship indicates “use.” Further, “Collabspace” refers to the agent or broker that conducts a human collaboration process, which is part of the extended business collaboration process. The example human collaboration process may be launching a chat program, creating a discussion thread in a discussion forum, and so forth. “0 . . . *” means that the association relationship is 1 to 0 or more, i.e., source class can be associated with zero or more instances of the target type where the straight arrow (→) is pointing to. In the example, Site can be associated with zero or more Organization classes, representing businesses entities. “1” refers to the association relationship being one to one.

The detailed description now turns to a second important aspect of the CxP plug-in framework, namely, delegation.

It is to be understood that, in accordance with the framework, there is an overall plug-in package, and underneath the package, each plug-in scenario is organized in their respective sub plug-in packages, e.g., one for Design Initialization, one for Design Refinement, one for Engineering Change, and one for Opportunity Launch, etc. Each package contains definitions of the new CxP message or data entities definitions, message sending and processing as required for the new scenario, identified via the life cycle process mentioned above.

The CxP base is responsible for checking and validating the base data entities and base CxP message types. When the CxP base encounters a data or message type it does not recognize, CxP base will invoke methods in the plug-in packages, which are responsible for additional new data entities and messages added in those packages. First the overall plug-in package is invoked, which is responsible for invoking the sub plug-in packages that are under it. The linkage from the base to the overall plug-in package is already made in the base and, therefore, there is no need to change the base when adding support to the plug-ins. When a new sub package is added, only the overall plug-in package needs to be changed. The main portion of changes for each new scenario stay in the sub plug-in packages.

FIG. 12 is a diagram illustrating an overall delegation mechanism from base to plug-in packages, according to an embodiment of the present invention. More particularly, FIG. 12 shows the overall delegation mechanism from the base to the overall plug-in package, and then to the actual sub plug-in package for the specific collaboration scenario. CxP Base 1200 is the basic class for extended business collaboration. It includes a plug-in module 1201, which includes Central Plugin 1202. Central Plug-in 1202 can be extended to deal with specific scenarios. The corresponding plugins are DesignInit Plug-in 1203 for handling Design Initialization, DesignRefine Plugin 1204 for handling Design Refinement, EngineerChang Plugin 1205 for handing Engineering Change management, and OppLaunch 1206 for handling Opportunity Launch.

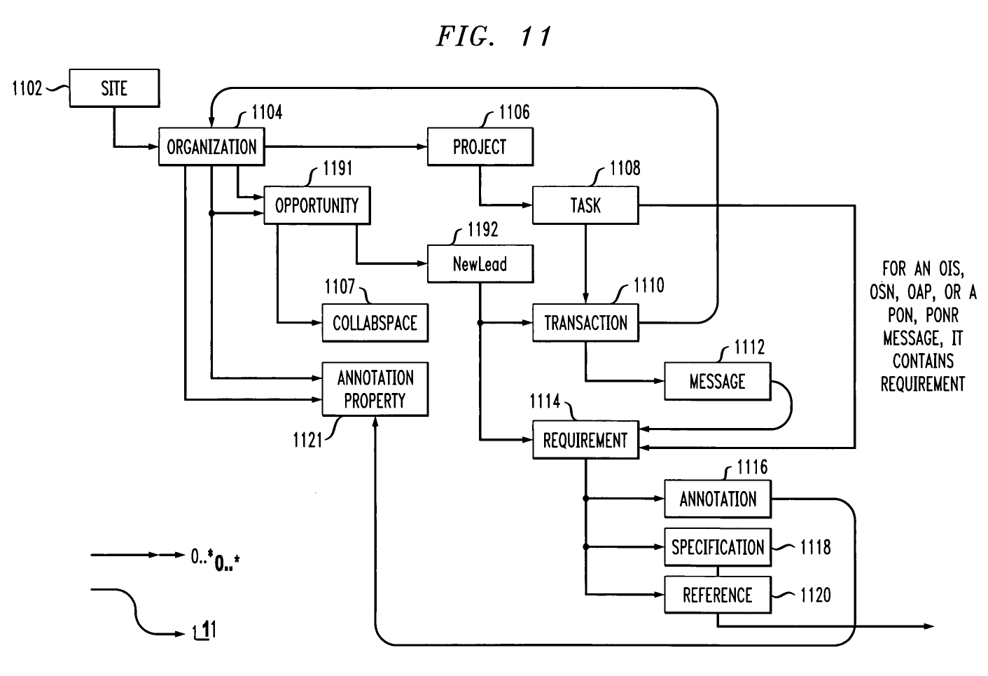

FIG. 13 is a diagram illustrating a collaborative exchange protocol message processing delegation mechanism from base to plug-in packages, according to an embodiment of the present invention. More particularly, FIG. 13 shows the delegation mechanism for processing CxP messages, i.e., the CxP message processing delegation mechanism from base to plug-in packages. SOAPMessage Sender class 1301, Message class 1302, Transaction class 1303, and ModelHelper 1304 pass CxP messages to a delegation module, PlugInUtils (Plugin Utilities) 1305, which routes the received CxP messages to the corresponding scenario-specific modules such as DesignInitUtils 1306 for processing Design Initialization related messages, DesignRefineUtils 1307 for processing Design Refinement related messages, EngineerChangeUtils 1308 for processing Engineering Change management related messages, and OpptLaunchUtils 1309 for processing Opportunity Launch related messages.

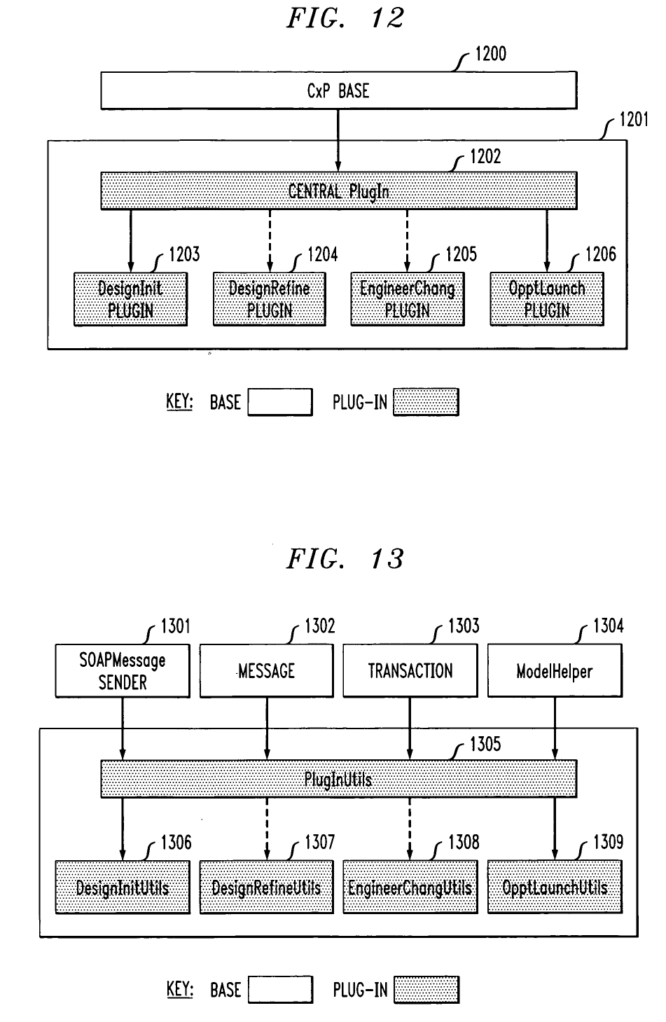

FIG. 14 is a diagram illustrating an application programming interface (API) delegation mechanism from base to plug-in packages, according to an embodiment of the present invention. More particularly, FIG. 14 shows the delegation mechanism for processing at the API layer where the base CollabMgr 1401 invokes the PlugInCollabMgr 1402, which in turn invokes the appropriate Collaboration Manager for an individual scenario, i.e., Design Initialization (DesignInitCollabMgr 1403), Design Refinement (DesignRefine CollabMgr 1404), Engineering Change (EngineerChangeCollabMgr 1405), and Opportunity Launch (OpptLaunchCollabMgr 1406).

The detailed description now turns to a third important aspect of the CxP plug-in framework, namely, containment of changes or isolation.

The stability of the base system is of paramount importance while multiple parties are engaging in parallel development of extensions. Without base system stability, none of the extensions would work properly. In addition, one extension should not interfere with another, which is important both during development time as well as runtime.

With respect to the containment feature of the CxP plug-in framework of the invention, all changes needed to support a new plug-in scenario are self-contained within the appropriate plug-in package, without affecting the CxP base or other scenarios at either development or runtime. Such isolation effectively eliminates the need for regression testing of the CxP base or existing scenarios, which is a considerable savings in cost and time during development and testing cycles, thus speeding up deployment.

II. CxP Primitives and Business Construct Templates

As explained above, the CxP stack comprises multi-layers based on a transport Layer such as SOAP. Recall that the stack may comprise a message layer, collaboration primitives (such as RFI, IS, etc.) layer, a business constructs (comprising multiple primitives) layer, and business scenario (comprising multiple business constructs) layer.

One important aspect of customizing the CxP is the ability to provide templates for both CxP primitives and business constructs. Standard business process modeling languages such as Business Process Execution Language (BPEL4WS) or property files can be used to describe the messages that comprise each primitive, as well as the primitives that comprise each business construct.

With the templates, new CxP primitives and business constructs can be created through the customization and configuration of the existing ones. During the first half of the design and modeling phase of the life cycle, the collaboration protocols are defined. The templates for exiting primitives and business constructs are examined for validity and modified to fit the needs. Various atomic CxP Messages can go together to form a new CxP primitive, and by the same token, various atomic CxP primitives can go together to form a new business construct.

One of the important usages of CxP business construct templates is for a graphical user interface (GUI), such as a portal, to extract the business process flow sequence and use that sequence to display the corresponding screens. Thus, a business construct template also serves as the description for the screen flow for the business exchange at hand.

In remainder of this section (section II), an RFI business construct is used as an example to illustrate the process of creating and describing the templates, using BPEL4WS as the descriptive language.

RFI business construct comprises RFI primitive and IS primitive. First, we need to describe the CxP messages that go into each of the two primitives. Then, we show how the two primitives can be configured to form the RFI business construct.

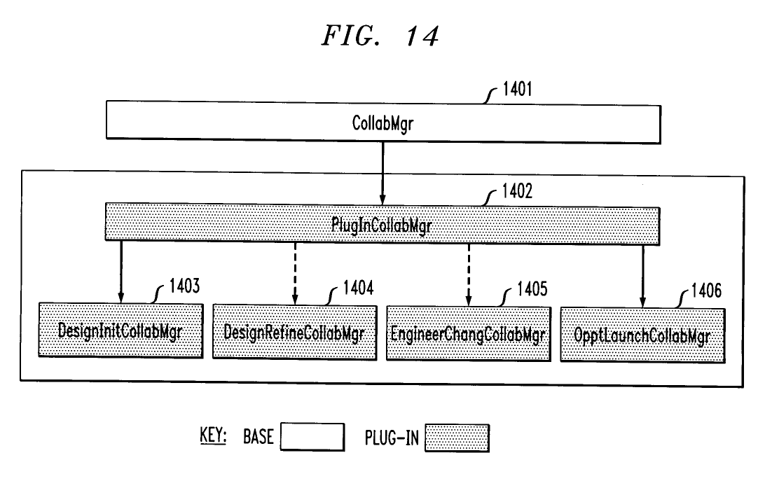

FIG. 15 is a diagram illustrating a request for information (RFI) primitive, according to an embodiment of the present invention. More particularly, FIG. 15 depicts the multiple CxP Message exchanges for an RFI primitive, which is a group of CxP message exchanges for a specific and micro design collaboration goal for updating resources in the context of eBC. The flow 1500 is as follows:
Partner A sends out RFI Message to Partner B (1502);
Partner B sends acknowledgment back to Partner A to indicate Partner B has processed the RFI request (1504); and
Send and process IS request; see IS Primitive (1506)

Note that both parties can send RFI.

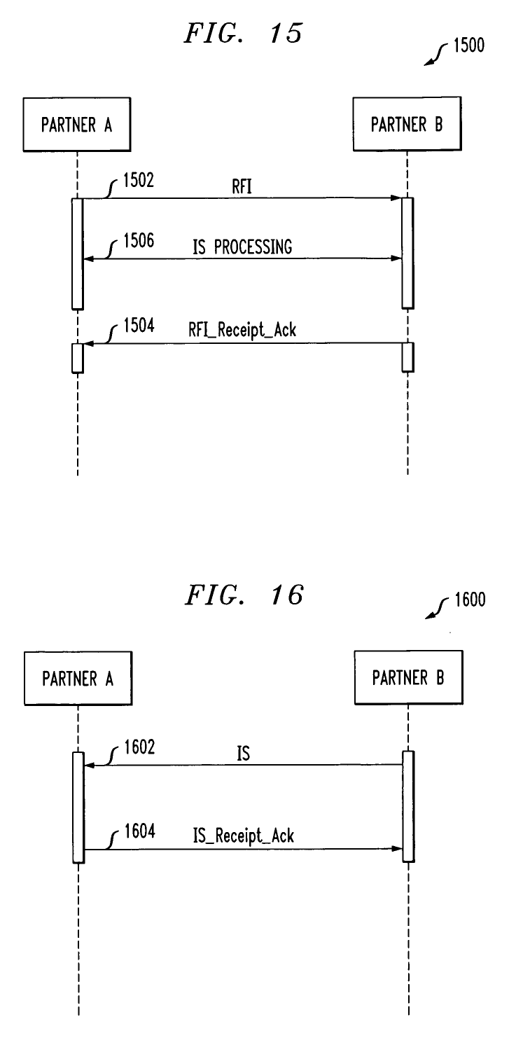

FIG. 16 is a diagram illustrating an information submission (IS) primitive, according to an embodiment of the present invention. More particularly, FIG. 16 depicts the multiple CxP Message exchanges for an IS primitive. Partner B collects the required information content and sends it via an IS message to Partner A (1602). Partner A processes IS message, retrieves the information content, saves it to local inbox, and sends and acknowledgment back to Partner B (1604).

Note that both parties can send IS.

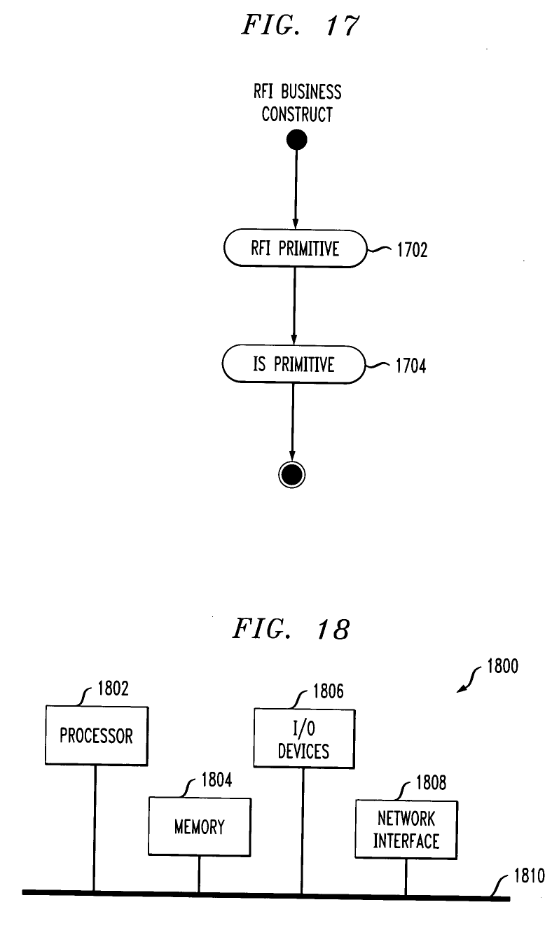

FIG. 17 is a diagram illustrating an RFI business construct, according to an embodiment of the present invention. As previously explained, a business construct is a group of predefined primitives. In FIG. 17, an RFI business constructs is shown to comprise RFI primitive 1702 plus IS primitive 1704

List 5 below describes the composite flow of RFI and IS primitives as represented by BPEL4WS:

List 5. RFI micro flow represented by BPEL4WS

<process name= “RFImicroflow”

targetNamespace=“urn:samples:BusinessConstructs”
xmlns:tns=“urn:samples:BusinessConstructs”
xmlns=“http://schemas.xmlsoap.org/ws/2003/03/business-process/”>

<partners>

<partner name=“RFIrequestor”

serviceLinkType=“tns:RFIrequestorSLT”
myRole=“RFIrequesting”/>

<partner name=“RFIoriginator

serviceLinkType=“tns:RFIoriginatingSLT”
myRole=“RFIoriginating”/>

<partner name=“RFIreceiver”

serviceLinkType=“tns:RFIreceivingSLT”
myRole=“RFIreceiving”/>

</partners>
<variables>

<variable name=“RFIinvoke” messageType=“tns:RFIinvoke”/>

<variable name=“RFImsg” messageType=“tns:RFImsg”/>

<variable name=“RFI_Receipt_Ack”

messageType =“tns:RFI_Receipt_Ack”/>

<variable name=“ISinvoke” messageType=“tns:ISinvoke”/>
<variable name=“ISmsg” messageType=“tns:ISmsg”/>
<variable name=“RFIreply” messageType=“tns:RFIreply”/>

</variables>

<correlationSets>

<correlationSetname=“RFIIdentifier”properties=“RFIIdentifier”/>

</correlationSets>

<sequence>

<receive partner=“RFIrequestor” portType=“tns:RFIrequestorPT”

operation=“requestInfo” variable=“RFIinvoke”
createInstance=“yes” name=“RFIrequestReceive”>
<correlations>
<correlation set=“RFIIdentifier” initiate=“yes”/>

</correlations>

</receive>
<invoke name=“invokeRFIoriginator”

partner=“RFIoriginator” portType=“tns:RFIoriginatorPT”

operation=“sendRFI” inputVariable=“RFIinvoke”
outputVariable=“RFImsg”>

</invoke>
<invoke name=“invokeRFIreceiver”

| partner=“RFIreceiver” portType=“tns:RFIreceiver” | |
|---|---|
| operation=“receiveRFI” | inputVariable=“RFImsg” |

outputVariable=“RFI_Receipt_Ack”>

</invoke>
<invoke name=“invokeIS”

partner=“RFIreceiver” portType=“tns:RFIreceiver”
operation=“submitIS” inputVariable=“ISinvoke”

outputVariable=“ISmsg”>

</invoke>

<invoke name=“invokeIS_receive”

| partner=“RFIoriginator” portType=“tns:RFIoriginator” | |
|---|---|
| operation=“receiveIS” | inputVariable=“ISmsg” |

outputVariable=“IS_Receipt_Ack”>

</invoke>

<replypartner=“RFIrequestor” portType=“tns:RFIrequestorPT”

operation=“requestInfo” variable=“RFI”

</reply>

</sequence>

</process>

Referring finally to FIG. 18, a block diagram illustrates an illustrative hardware implementation of a computing system in accordance with which one or more components/methodologies of the present invention (e.g., components/methodologies described in the context of FIGS. 1 through 17) may be implemented, according to an embodiment of the present invention. For instance, such a computing system in FIG. 18 may implement a CxP plug-in interface, a hyperchain manager, an eBC manager, a portal/dashboard, etc. (as shown in FIGS. 1 and 2).

It is to be understood that such individual components/methodologies may be implemented on one such computer system, or on more than one such computer system. In the case of an implementation in a distributed computing system, the individual computer systems and/or devices may be connected via a suitable network, e.g., the Internet or World Wide Web. However, the system may be realized via private or local networks. The invention is not limited to any particular network.

As shown, computer system 1800 may be implemented in accordance with a processor 1802, a memory 1804, I/O devices 1806, and a network interface 1808, coupled via a computer bus 1810 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc.

In addition, the phrase “input/output devices” or “I/O devices” as used herein is intended to include, for example, one or more input devices (e.g., keyboard, mouse, etc.) for entering data to the processing unit, and/or one or more output devices (e.g., speaker, display, etc.) for presenting results associated with the processing unit. Further, such output devices may also be used to present one or more graphical user interfaces associated with the invention.

Still further, the phrase “network interface” as used herein is intended to include, for example, one or more transceivers to permit the computer system to communicate with another computer system via an appropriate communications protocol.

Accordingly, software components including instructions or code for performing the methodologies described herein may be stored in one or more of the associated memory devices (e.g., ROM, fixed or removable memory) and, when ready to be utilized, loaded in part or in whole (e.g., into RAM) and executed by a CPU.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

1. A method for use in at least one of creating and customizing a business collaboration protocol, the method comprising the steps of:
adding one or more new data entities to be associated with the business collaboration protocol;
adding one or more new messages usable to communicate between a plurality of data entities, including at least a portion of the one or more new data entities;
creating one or more collaboration primitives comprising a set of messages, including at least a portion of the one or more new messages; and
creating one or more business constructs comprising a set of collaboration primitives, including at least a portion of the one or more created collaboration primitives, usable for attempting to substantially achieve a business goal.

2. The method of claim 1, wherein the business collaboration protocol comprises a collaborative exchange protocol (CxP).

3. The method of claim 1, wherein the step of adding one or more new data entities further comprises the steps of:
determining the one or more new data entities to be added based on base entities, without affecting the base entities;
creating one or more ontology definitions; and
creating an implementation package for the one or more new data entities that substantially enforces the one or more ontology definitions.

4. The method of claim 3, further comprising the step of creating an ontology context file.

5. The method of claim 4, wherein the ontology context file comprises an Extensible Markup Language (XML) file.

6. The method of claim 3, further comprising the step of creating one or more Java classes for the one or more new data entities that substantially enforce the one or more ontology definitions.

7. The method of claim 3, wherein the step of creating an implementation package further comprises one or more of the new data entities having one or more dependent elements associated therewith.

8. The method of claim 7, wherein at least one of the dependent elements distinguishes its parent entity type using an ontology context file.

9. The method of claim 3, wherein the one or more ontology definitions are expressible in accordance with a resource description framework (RDF).

10. The method of claim 3, wherein the step of determining the one or more new data entities to be added further comprises creating the one or more new data entities through extending or inheriting from the base entities.

11. The method of claim 1, wherein the step of adding one or more new messages further comprises the step of creating the one or more new messages by extending one or more existing messages.

12. The method of claim 11, further comprising the step of processing the one or more new messages using a single interface.

13. The method of claim 12, wherein the single interface is represented in accordance with a Web service description language (WSDL).

14. The method of claim 1, wherein the step of creating one or more collaboration primitives further comprises the steps of:
creating a flow for the set of messages between a plurality of data entities using one of a predefined flow template and a manual operation; and
generating at least one implementation interface for the one or more collaboration primitives.

15. The method of claim 14, wherein the predefined flow template comprises one of a property file and an XML document.

16. The method of claim 14, wherein the at least one implementation interface comprises one of a Java application programming interface and a Web services interface.

17. The method of claim 1, wherein the step of creating one or more business constructs further comprises the steps of:
composing a flow for the set of primitives; and
representing the flow in a readable format.

18. The method of claim 17, wherein the readable format comprises an XML syntax.

19. The method of claim 18, wherein the XML syntax is in the form of a Business Process Execution Language for Web Services (BPEL4WS).

20. The method of claim 1, further comprising the step of multiple parties developing data entities and messages simultaneously within multiple business scenarios, wherein the multiple business scenarios are independent of one another.

21. The method of claim 1, further comprising the step of processing the one or more new added messages using a delegation mechanism that redirects the one or more new messages to an appropriate plug-in package without affecting an existing message processing engine.

22. Apparatus for use in at least one of creating and customizing a business collaboration protocol, the apparatus comprising:
a memory; and
at least one processor coupled to the memory and operative to: (i) enable the addition of one or more new data entities to be associated with the business collaboration protocol; (ii) enable the addition of one or more new messages usable to communicate between a plurality of data entities, including at least a portion of the one or more new data entities; (iii) enable the creation of one or more collaboration primitives comprising a set of messages, including at least a portion of the one or more new messages; and (iv) enable the creation of one or more business constructs comprising a set of collaboration primitives, including at least a portion of the one or more created collaboration primitives, usable for attempting to substantially achieve a business goal.

23. An article of manufacture for use in at least one of creating and customizing a business collaboration protocol, comprising a machine readable medium containing one or more programs which when executed implement the steps of:
adding one or more new data entities to be associated with the business collaboration protocol;
adding one or more new messages usable to communicate between a plurality of data entities, including at least a portion of the one or more new data entities;
creating one or more collaboration primitives comprising a set of messages, including at least a portion of the one or more new messages; and
creating one or more business constructs comprising a set of collaboration primitives, including at least a portion of the one or more created collaboration primitives, usable for attempting to substantially achieve a business goal.

24. A model for use in at least one of creating and customizing a business collaboration protocol, the model comprising facilities for enabling performance of the steps of:
adding one or more new data entities to be associated with the business collaboration protocol;
adding one or more new messages usable to communicate between a plurality of data entities, including at least a portion of the one or more new data entities;
creating one or more collaboration primitives comprising a set of messages, including at least a portion of the one or more new messages; and
creating one or more business constructs comprising a set of collaboration primitives, including at least a portion of the one or more created collaboration primitives, usable for attempting to substantially achieve a business goal.

25. A method of providing a service, in accordance with a service provider, for at least one of creating and customizing a business collaboration protocol, the method comprising the step of:
deploying a business collaboration protocol interface operative to: (i) enable the addition of one or more new data entities to be associated with the business collaboration protocol; (ii) enable the addition of one or more new messages usable to communicate between a plurality of data entities, including at least a portion of the one or more new data entities; (iii) enable the creation of one or more collaboration primitives comprising a set of messages, including at least a portion of the one or more new messages; and (iv) enable the creation of one or more business constructs comprising a set of collaboration primitives, including at least a portion of the one or more created collaboration primitives, usable for attempting to substantially achieve a business goal.
